(19) United States
(12) Patent Application Publication
(10) Pub. No.: US 2007/0188759 A1
(43) Pub. Date: Aug. 16, 2007

(54) Colorimeter operating on color matching logic

(76) Inventors: Dhananjay Mehendale, Pune (IN); Ravindra Patwardhan, Pune (IN); Rajeev Pandit, Glastonbury, CT (US)

Correspondence Address: Rajeev Pandit, 2842 Main Street # 300, Glastonbury, CT, 06033, US

(21) Appl. No.: 11/731,865

(22) Filed: Apr. 2, 2007

Related U.S. Application Data
(60) Provisional application No. 60/792,370, filed on Apr. 17, 2006.

(30) Foreign Application Priority Data
Jan. 10, 2006 (IN) 32/MUM/2006
Jul. 28, 2006 (IN) 1193/MUM/2006

(51) Int. Cl. G01J 3/50; G01N 21/25

(52) U.S. Cl. 356/409

(57) ABSTRACT

A colorimeter operating on color matching logic concerned with a process of quantitatively analyzing a known substance by finding the color signature of the colored solution of that substance and matching it or interpolating it with the color values provided in the look-up table for that substance for determining the concentration of the substance in question. A memory means coupled with a microprocessor or a computer stores the calibration commands, computational routines and comparison logic and stores a plurality of color data corresponding to each biochemical, clinical pathological or chemical test for the substances that can possibly be quantitatively determined by the said colorimeter and the said data is stored in the form of look-up tables.

### BACKGROUND OF THE INVENTION

a) Field of the Invention

The present invention is concerned with a colorimeter and related process of quantitatively analyzing a colored solution of a known substance by finding the color signature of that solution and matching it or interpolating it with the color values provided in the look-up table for that substance for determining the concentration of the substance in question.

b) Description of Related Prior Art

The known substances being quantitatively determined by colorimetric procedures are frequently not colored or are only slightly so. They develop a colored compound through a chemical reaction or through a series of chemical reactions. The amount of color formed depends on the concentration of the substance, reagents used, and other conditions like temperature or incubation time.

At present, in majority of tests performed in biochemistry, clinical pathology or chemistry, quantitation of a known substance is based on a relationship between the absorption of light and the concentration of the substance being determined. Such quantitation can be done by using electrical means where the transmitted light is measured by means of a photocell/photodiode. The photocell/photodiode produces a small electrical current proportional to the intensity of the transmitted light incident on it. The measured current is then interpolated to convert into optical density.

The optical density is directly proportional to the concentration of the substance in the colored solution (Beer's law). Beer's law holds true only for light of a single wavelength. Monochromatic light is ideal. Photoelectric colorimeters usually include glass filters, which may have a bandwidth of 30-50 nm or more. Light emitting diodes (LEDs) are also used to produce a narrow wavelength but they also have a bandwidth of 35-60 nm. This naturally gives a less accurate result. Interference filters are available that have a narrower bandwidth but they are expensive. Spectrophotometers are also more accurate but are very expensive.

From Beer's law, we have C=KA where C refers to the concentration, A denotes absorbance (optical density) and K is a constant. If a test requires to run several standards of different concentration, many a times Beer's law does not hold and K value for the standard having a reading closest to a particular substance has to be used. Furthermore, even with the best instruments, it is difficult to read more accurately than 0.25% transmittance. This amounts to about a 1% variation in concentration. Besides, accuracy requires that the light intensity from the light source is the same for blank, standard and the test. If it is not, the measured intensity of the light incident on the solution will not be the same and error will result.

Often the reagents themselves give a certain amount of color to the final solution. This color constitutes reagent blank. One has to set the instrument to 100% transmittance with the blank solution. But if the reagents produce colors that are considerably different from those produced by the sample, it hinders accuracy.

Furthermore, a pathologist undertaking the testing of a sample faces a quaint problem. Generally, in a pathology laboratory, the tests are performed with the test kits, which are readily available in market. The test kits include reagent/reagents and a standard solution. One always wonders about the possible faulty manufacture of the said reagents and standard solution. One also wonders whether the said reagents and standard solution are decayed or decomposed or altered in handling, transport or storage. Meticulously preparing a standard solution of the test substance in one's own laboratory and checking the validity of the test kit can check this hazard. But this becomes a headache. Quality control of the test kits can also be undertaken by using available quality control samples with known ingredients having known concentration. But the reliability of these samples cannot be further counterchecked. There is a need of having an instrument, which bypasses this quality control dilemma.

The use of the pre-calibrated look-up tables is frowned upon as they are considered to lead to serious errors. One becomes apprehensive for errors due to improper factory calibration, variation between different instruments of the same make in regard to intensity and quality of a light source or stray light.

It is the object of present invention to avoid any occasion for the above-mentioned errors. It is also an object of the present invention to furnish the user with the most accurate test results than has been achievable hereinbefore.

Colorimeter of the present invention is an instrument for obtaining color signature of a colored solution of a known substance to be quantitatively determined by measuring its absolute red, blue and green color and/or extra frequency values and comparing and matching them with the stored data for that substance.

### BRIEF SUMMARY OF THE INVENTION

A colorimeter of the present invention operates on color matching logic for quantitatively determining a colored solution of a known substance. The said colorimeter comprises:

A ‘housing’ covering the colorimeter is so designed as to cover the entire functional instrument such that minimal ambient light or stray light is allowed to enter. An illumination means designed to generate a predefined intensity and quality of light to illuminate the object (a colored solution) to be analyzed. A sample-receiving chamber for positioning the said colored solution in a test tube, positioned between the illumination means and the light sensing means. A light sensing means for receiving the transmitted light and outputting electrical signals representative of the intensity of the transmitted light components in response to sensed light. The said light sensing means receives the transmitted/incident light and outputs electrical signals representative of the intensity of the transmitted/incident light components and generates color data of red, blue and green color components and/or extra frequency components (color signature) in response to sensed light.

Input means for inputting the name of the known substance to be tested quantitatively and the name of the manufacturer of the test kit used for that test. A microprocessor or a computer (computing means) coupled to the said light sensing means. A memory means coupled with the said microprocessor or the said computer for storing calibration commands, computational routines and comparison logic and for storing a plurality of color data (red, green, blue color and/or extra frequency/frequencies composition) corresponding to each biochemical, clinical pathological or chemical test for the substances that can possibly be quantitatively determined by the said colorimeter and the said data is stored in the form of look-up tables. Computing means for performing the color matching logic function, wherein, obtained color signature of the colored solution is used to select a pluro-stimulus value set from the corresponding look-up table which matches with it and determining the concentration of the said known substance by looking-up the corresponding value of the concentration. When exact match is not found, in such case, interpolating the color signature (the pluro-stimulus value set) with the array of corresponding look-up table pluro-stimulus values by regression analysis for determining the concentration of the said known substance.

Plurality of switches are coupled to the said computing means. They are used for switching ON the instrument, resetting, and commanding the instrument for operations in various modes etc.

A display means displays the test results.

### A BRIEF DESCRIPTION OF THE ACCOMPANYING DRAWINGS

FIG. 1 is a schematic representation of the array of components of the colorimeter for obtaining the color signature.

FIG. 2 is a schematic front view of the colorimeter of the present invention.

FIG. 3 is a schematic diagram depicting a layout of the electronic components as are used in the calorimeter of present invention.

FIG. 4 illustrates a flowchart of the sequence of steps pertaining to the calibration of the light source.

FIG. 5 illustrates a flowchart in accordance with the invented mechanism for finding the concentration of the test substance.

FIG. 6 depicts a flow chart of the operation of the instrument.

FIG. 7 is a schematic representation of an embodiment depicting the functional part of the colorimeter using reflection technique.

FIG. 8 is a schematic representation of another possible embodiment of the calorimeter using reflection technique.

### DETAILED DESCRIPTION OF THE INVENTION WITH REFERENCE TO DRAWINGS

### The Preferred Embodiment

The present invention is concerned with a colorimeter and related process for quantitatively analyzing a colored solution of a known substance.

The term ‘substance’ used in the present text is for substances like glucose, urea, uric acid etc, which are routinely tested for quantitative determination by colorimetric analysis in biochemistry or substance like hemoglobin in clinical pathology or metallic, nonmetallic, organic or inorganic substances in chemical analysis.

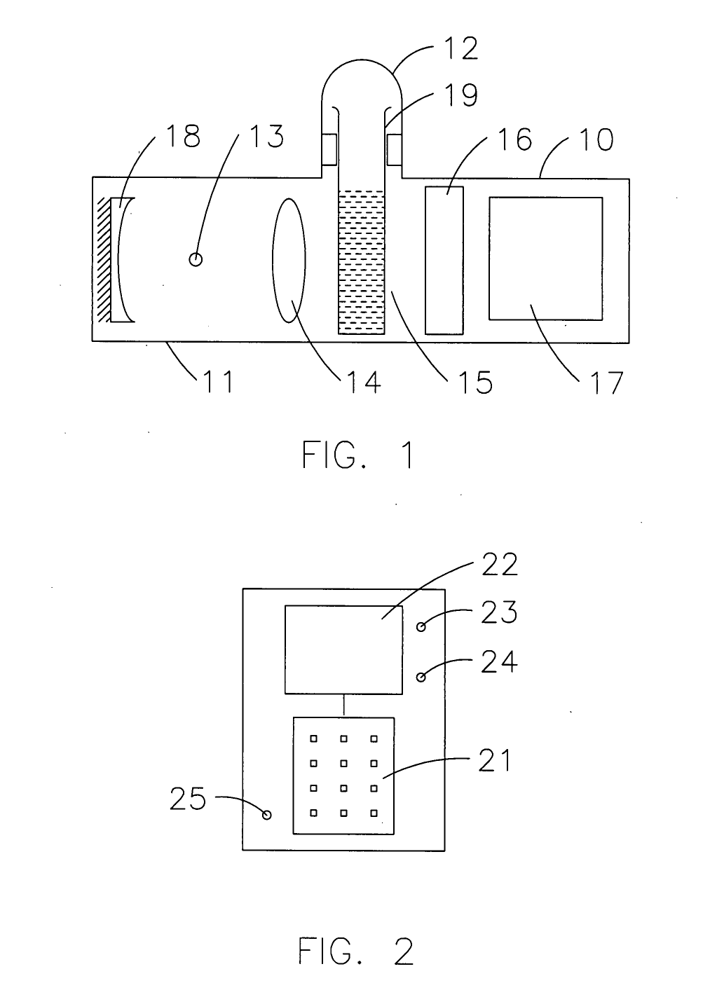

The FIGS. 1 and 2 illustrate a schematic representation of various views of the proposed instrument for the invented concept of a colorimeter operating on color matching logic. It depicts a conceptual representation and does not portray the actual instrument. Referring to FIGS. 1 and 2, it can be seen that the colorimeter 10 comprises of a housing 11, a lid 12 to cover an object (a test tube containing a colored solution), an illumination means comprising of a light source 13 a lens 14 and a mirror 18, a sample-receiving chamber 15 and a light sensing means 16. The said sample-receiving chamber is a mechanism to hold the object 19 (a test tube containing a colored solution) in such a way so as not to hinder the path of incident/transmitted light. Block 17 schematically depicts the signal conditioning unit, CPU and memory block taken together. The exterior of the calorimeter (FIG. 2) includes a power switch 25, a keyboard 21, status indicator LED 24, a reset switch 23 and a display unit 22. The case of the housing covering the colorimeter is so designed as to cover the entire functional instrument and no or minimal ambient light/stray light is allowed to enter. Interior of the housing is preferably black in color.

Mirror 18 of the illumination means is a concave mirror and is positioned such that the illumination means (light source) is at the pole of the concave mirror, so that the light is reflected back to source from the concave mirror and travels in desirable direction. The said concave mirror is positioned near the light source such that the light source is between the mirror and the said sample-receiving chamber. Use of the mirror is optional and is particularly used if the light source has substantial backward emission.

The light from the light source is transmitted through a lens 14 of the illumination means, which is positioned such that the light source is at the focal point of the lens, which directs the light beam in a parallel fashion incident on the object 19. The said lens for collimation purpose is aligned between the light source and the sample-receiving chamber. The light source of the said illumination means is positioned at the focus of the said lens so that a parallel light is produced on the other side of the lens to be made incident on the colored solution (object 19). Use of the lens is optional.

Power supply, which is either a battery supply or an adapter, is connected to the said calorimeter to provide electrical power. Alternatively an internal power supply circuitry to condition the external power input may be used.

The substance being quantitatively determined is invariably converted into a colored solution through respective specific chemical reaction/reactions.

The illumination means is employed to illuminate the object 19. The said object is preferably a square test tube containing the said colored solution of a known substance to be quantitatively determined and placed in the sample-receiving chamber 15. The round variant of the test tube can also be used. Object 19 is to be inserted in the sample-receiving chamber 15. The incident light of the illumination means is transmitted through the object 19, which in turn falls on the light sensing means 16.

Alternatively, as a wave-guide and for avoiding the ambient light, a light guiding means like fiber-optic tube can be used between a light source and the object giving a parallel light, or such a light guiding means like a fiber-optic tube can be used between the said lens of the light source and the object.

The illumination means preferably includes a light source giving white light of known quality and intensity. Red, green and blue lights combined to give white light are preferable. Or other appropriate basic colors producing white light or other appropriate basic colors suitable for color measurement can also be used. Alternatively, red, green and blue (RGB) lights along with sources emitting extra frequencies like ultra violet (UV), infra-red (IR) etc. (like R, G, B light emitting diodes, IR light emitting diode, and UV light emitting diode) are used.

The light source can be a halogen lamp or a light emitting diode (LED) or a neon lamp or a xenon lamp or a light bulb or red, blue and green light emitting diodes combined to emit white light or R, G, B lasers giving a white light or a laser emitting white light, or any other means for giving a white light and/or extra frequency/frequencies of known quality and intensity.

White light contains all frequencies lying in the visible light spectrum.

Instead of only the white light as a source as is a norm of the present colorimetric operations, we propose a novel concept of using electromagnetic frequencies which lie external to the visible electromagnetic spectrum [Extra Frequency or EF], like ultra violet (UV), infra-red (IR) etc., in addition to or a complete replacement to the white light source. Here, the illumination means is formed by having light sources emitting UV, IR etc. like IR LED (Light Emitting Diode), UV LED etc. in addition to or a complete replacement to the white light source. Naturally, the light sensing means used is responsive to such frequencies as well as to white light and gives electrical signal output proportional to the corresponding extra frequency/frequencies (EF) components and the RGB components in the light incident on it. Here, the light sensing means is formed of sensors responsive to EF along with the sensors responsive to white light. This light sensing means can be a single sensor, wherein; the EF responsive component is embedded inside the white light responsive sensor. Or a separate EF sensor is placed such that the transmitted light is incident on EF as well white light sensor.

The herein before mentioned RGB and EF emitters and sensors are readily available in the market and are used in many appliances. Some of the products typically integrate various emitters or sensors to cover a wider range of electromagnetic frequencies ranging from IR to UV frequencies. As an example, we are quoting some of the available market products, which provide a wide range of spectral response:

Light sources like: CrimeScope CS-16-400/CrimeScope CS-16-500. The CS-16-400 is as bright as xenon 500 W, containing 22 Wavelengths covering the UV-visible-IR range. And light sensors like: Toshiba CCD sensor: TCD1304AP (3648×1) [8×200 μm] L=29.2 mm (Spectral response 190-1100 nm) or Hamamatsu photodiode array (PDA) sensors which comprise of high dynamic range photodiode arrays with spectral response from 200 to 1000 nm or Sony CCD sensor: ICX-285 CCD or Synapse E2V CCD sensors: E2V CCD30 or TAOS photodiode arrays.

Modern colorimetry is based on tristimulus color measurement, and a lot of work is based on the analysis of tristimulus components emitted from the surface of the object in question (e.g. related to monitor screen, fruits, paints etc.). The proposed usage of EF, namely, UV, IR etc. add extra dimensions to the analysis based on the transmitted/reflected light components. Instead of tristimulus, we can have a pluro-stimulus (e.g. R, G, B, UV, IR components taken together in a set) value set. Such a set of pluro-stimulus values is called as color data hereinafter.

In other words, the coined word ‘pluro-stimulus values’ means value/values representing one or more of the components lying anywhere in the electromagnetic radiation spectrum. Said pluro-stimulus values in combination are measured and are used to match with a stored data for quantitative determination of a known substance.

Colorimeters are based on the analysis of tristimulus/RGB components. Even though chemicals present in the colored solution have a specific color, and hence emit visible frequencies, they may be responsive, to EF light as well, by means of partially absorbing and/or emitting EF light. Addition of each of the said component, thus, will add to the analytic specificity and precision. In consequence, calorimeters based on the measurement of pluro-stimulus value set, for the quantitative analysis of a known substance, will achieve higher accuracy.

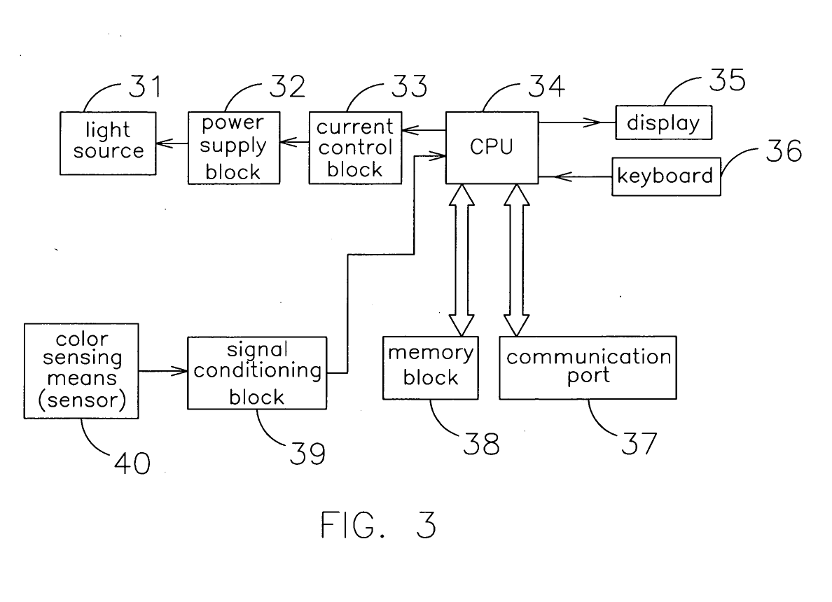

FIG. 3 is a schematic diagram of the control system for controlling the desired quality and intensity of the light source of the instrument. All the signals from the light sensing means (sensor block 40) are conditioned (signal conditioning block 39) and supplied to central processing unit (CPU) 34. Controlling the power supply and attuning the intensity of the light source is executed by the CPU 34 via the driver block/current control block 33 and the power supply block 32 so that the light source (block 31) achieves desired defined output. CPU 34 is connected by two-way bus with the memory block 38 and the communication port 37. Keyboard 36 is for inputting the relevant data in the CPU 34. The display block 35 displays various texts/images.

Accuracy of a test result in present invention requires that the quality and the intensity of the light of the light source, i.e. its RGB and/or EF composition, should be very similar in factory calibration as well as in an instrument used in any laboratory. This is necessary because each of the look-up table obtained is based on this reference value of constant quality and intensity of the incident light for their measurements.

For the purpose of maintaining a constant defined intensity and quality of light output, the present invention uses a closed loop control mechanism to keep the light source at a predetermined intensity and quality.

The driver block/current control block controls the amount of each of the R, G, B and/or EF components of the light source separately or as a whole, so as to achieve the desired defined intensity and quality of the light source. This is typically achieved by varying the current and/or the voltage supplied to each of the included light source element/s. This voltage/current is varied either by varying the supply voltage/current or any other parameter which would result in such variation.

For example, the output voltage of a DAC (Digital to Analog Converter) serves as the input voltage to the light source. In order to control individual components of the light source, a multi-channel multi-output DAC or separate DAC unit per light source component is used to control the R, G, B and/or EF composition of the light source. The output of DAC depends on the binary/digital input given to it by the CPU. We thus have Intensity proportional to Voltage output of DAC, which in turn is proportional to the digital data inputted to it. Thus, by varying the digital input from CPU to DAC, the ultimate intensity and hence RGB and/or EF composition of the light source is achieved.

Instead of the DAC unit, one can also use a direct current chopper or a pulse width modulation (PWM) voltage controller to generate a variable voltage at the output of driver block.

The color sensing means (sensor) is typically a charge-coupled device (CCD) image sensor, which senses the incident light (transmitted/reflected) and outputs a set of signals representing the RGB and/or EF composition of the incident light in a form, which could be fed to the CPU. This can either be a digital signal in its raw form or encoded or scaled via a signal-conditioning unit. Whenever indicated, the CPU stores this RGB and/or EF value set (the pluro-stimulus value set) in the memory means.

The light source needs to be calibrated prior to the testing of the test solution. This is necessary to maintain a constant defined intensity and quality of light output of the light source. This is done by a closed loop feedback mechanism with the help of calibration commands as explained herein below.

Calibration commands are basically the control signals issued by the CPU in order to carry out the process of calibration. The software stored in the memory means generates these calibration commands.

The calibration of the light source and the sensor is done automatically in a closed loop each time the colorimeter is switched ON and the lid is in a closed status and the object is not inserted. The construction of the housing of the calorimeter allows minimal or no ambient light, and the light source inside the colorimeter, if switched on, is the only source of light.

The light sensing means (sensor) may be comprised of array of sensors where each sensor is adapted to produce an electrical signal when light impinges thereupon. The said sensor receives the incident/transmitted light and outputs the two-dimensional array of pixels (the picture element), henceforth called as an image. The sensor outputs electrical signals representative of the intensity of the incident light components in response to sensed light.

Intended for convenience, for describing the current control mechanism, we have considered the representative pluro-stimulus value set to be depicted by RGB, which is a subset of the pluro-stimulus value set.

The following description elucidates one of the possible ways of controlling the light source.

The output of the sensor when the light source is in a switched off state (dark image) is obtained and recorded as (R_{d}, G_{d}, B_{d}). The dark image is a result of noise (for example the thermal noise), or presence of physical anomalies in the sensor.

As soon as the dark image is obtained and recorded, the CPU switches ON the light source. In this present status, in absence of the object, the light from the light source is directly incident on the sensor. This output of the sensor is obtained (Rᵢ, Gᵢ, Bᵢ) and recorded as source image, which includes the output of the light source plus the dark image. The dark image (R_{d}, G_{d}, B_{d}) is subtracted from this source image (Rᵢ, Gᵢ, Bᵢ) and the corrected RGB values are obtained (Rᵢ−R_{d}, Gᵢ−G_{d}, Bᵢ−B_{d}). The desired defined RGB value is stored in the memory means and is denoted as (Rₛ, Gₛ, Bₛ). During the calibration, the CPU compares the obtained corrected RGB values with the desired defined RGB value.

The present invention aims at meticulous control, for each unit of the colorimeter operating on color matching logic, of the quality and intensity of the light from the light source incident on the object, and ensures a match (within reasonable tolerance limits) between the light source of the unit that is used in preparing the look-up tables and the light source of any unit that is used by any of the end users. And this is the reason for storing the desired defined RGB values (Rₛ, Gₛ, Bₛ) in the memory means, which are used as reference values for attuning the said light source. In other words, the calibration mechanism tries to match the corrected RGB values with the desired defined RGB values as close as possible until the overall deviation of the individual RGB components of the light source from the said desired RGB values is minimized to its possible and acceptable/permissible tolerance limits.

The sensor present in each unit is bound to be a bit different in regard to the sensed output because of the manufacturing and/or material variation leading to the presence of noise in the output in the form of an offset. In addition to this noise, there could also be other sources of noise like thermal noise or stray/ambient light etc. This collective noise is typically not of the same magnitude across different units. Hence, to avoid the error due to this said noise, it is necessary to make the readings independent of this noise. And for the same reasons, there cannot be a static correction. Therefore, the philosophy, which achieves this said independence, is to attune the light source and then to correct the final image. Here, at the end of attunement of the light source, the sensed light by the light sensing means: output of the attuned light source (Rₛ, Gₛ, Bₛ)+the added dark image (R_{d}, G_{d}, B_{d})=(Rᵢ+R_{d}, Gᵢ+G_{d}, Bᵢ+B_{d}). The final image (image of the test solution) is then corrected by subtraction of dark image from the final image.

If the said corrected RGB values are not equal to (Rₛ, Gₛ, Bₛ), then the current is attuned (increased if less and vice versa) so as to make this corrected RGB value equal to (Rₛ, Gₛ, Bₛ). This is done in conjunction with the current control block (CCB) 33. This feedback control is implemented in software using any of the feedback control mechanisms/algorithms like PID (Proportion-Integration-Derivative) emulation. The CCB 33 comprises of any of the necessary hardware like PID control, variable current source, voltage/current regulators, noise reduction circuits etc.

Thus, considering the dark image and the attuned light source, the pre-test sensed light by the sensor is (Rₛ+R_{d}, Gₛ+G_{d}, Bₛ+B_{d}).

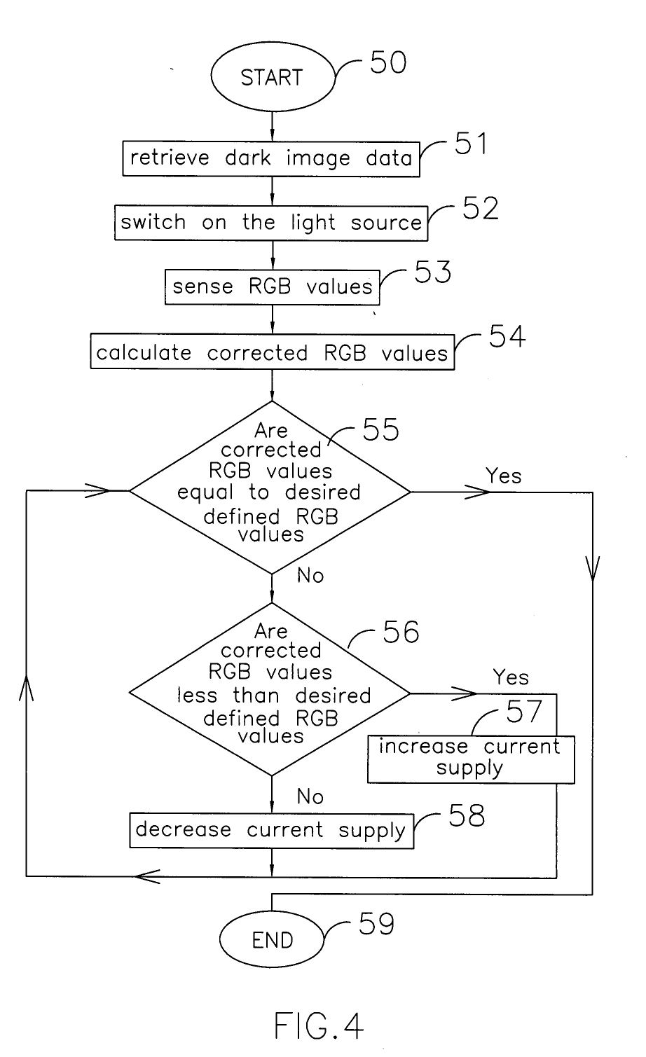

The said attunement is undertaken as depicted in the FIG. 4, wherein; block 50 depicts start of the process. Block 51 depicts the process of retrieving the stored dark image from the memory. Subsequently, the light source is switched ON by the CPU (Block 52). The RGB values (Rᵢ, Gᵢ, Bᵢ) are sensed (Block 53) in absence of the object. The dark image (R_{d}, G_{d}, B_{d}) is subtracted from this sensed output of the light source (Rᵢ, Gᵢ, Bᵢ) and the corrected RGB values (Rᵢ−R_{d}, Gᵢ−G_{d}, Bᵢ−B_{d}) are obtained (Block 54). Decision diamond 55 checks whether the corrected RGB values are equal to or within acceptable limits as compared to the desired defined RGB values (Rₛ, Gₛ, Bₛ). If they are not within the acceptable limits, then decision diamond 56 checks whether corrected RGB values are less than the desired defined RGB values, and if found less, then step 57, which denotes increasing the current, is executed and then decision diamond 55 is followed. If corrected RGB values are not less than the desired defined RGB values (in other words, corrected RGB values are more than the desired defined RGB values), then step 58, which denotes decreasing the current supply, is executed and then decision diamond 55 is followed. If the corrected RGB values are within the acceptable limits as compared to the desired defined RGB values (decision diamond 55), then the process ends as in step 59.

Here, at times, we may find that the RGB values of the light source are such that each of those components cannot be made exactly equal to each of the said desired component values but are within a minimum error range/level i.e. the acceptable limit. One of the possible reasons is that one or more of the light source components are inherently defective resulting into a permanent offset in one or more of the RGB components. At times, such components may remain on the extreme side of the minimum error range/level and couldn't be attuned. In such circumstances the computing means automatically undertakes the following corrective measures.

Consider that final attuned RGB values are noted down and stored in the memory means as (R_{f}, G_{f}, B_{f}) where the subscript ‘f’ denotes the final attuned value within acceptable limits but having a significant error. This (R_{f}, G_{f}, B_{f}) value set is then used in the further calculations.

Typically, this (R_{f}, G_{f}, B_{f}) value set is used to re-define the respective look-up table, which is then used to analyze the test sample. This said redefinition could be done in various ways as given below.

The components amongst the (R_{f}, G_{f}, B_{f}) value set which are deviated from the said desired RGB values are chosen and the value of the corresponding component in the look-up table is redefined by adding/subtracting the offset (Rₛ˜R_{f}) or (Gₛ˜G_{f}) or (Bₛ˜B_{f}) so that the table gets compensated and adjusted in a linear way.

Thus the redefinition comprises:

If one or more of the components of illumination means (for example Red, Green, Blue, UV or IR LEDs) are inherently defective resulting into a permanent offset in one or more of the frequency components, then such deviated frequency components are chosen. The values of the corresponding components in the look-up table are redefined by adding/subtracting the deviated amount. For example, if R component is lesser than the desired value, then the value (Rₛ−R_{f}) is subtracted from all the R values in the look-up table related for that particular test solution (where R_{f} is the final attuned value of R component), so that the table gets adjusted in a linear way.

Here, the linear adjustment may not be valid if the absorption of the light component is not linearly proportional to the concentration. In such cases, the said deviated amount is modified and used to redefine the look-up table, where the modification is consistent with the absorption characteristics. In other words, the methods of using the said offsets (Rₛ ˜R_{f}) or (Gₛ˜G_{f}) or (Bₛ˜B_{f}) in redefinition of the look-up table include altering their values consistent with the absorption characteristics of the respective substance in the colored solution.

The amount of light components absorbed by the test sample is dependent on the temperature of the sample. Consequently, the light components transmitted are also temperature dependent. We advise that the technicians performing the tests should follow the kit-manufacture's guidelines related to the temperature control (for example: room temperature or 37 degree centigrade etc.) for that particular test. However, if the guidelines are ignored, then the inbuilt temperature sensing mechanism will automatically determine the temperature of the test solution, and if there is a significant mismatch as per the guidelines, then this difference is used to redefine the look-up table values. This redefinition is dependent on the temperature characteristics for that particular test which is already inputted. These temperature characteristics are derived by regression analysis of the data acquired from the experiments carried out at different reference temperatures. This regression analysis is used to re-establish the relationship between the pluro-stimulus values and the corresponding concentration suitable for the corresponding temperature.

The said light sensing means may be comprised of an array of sensors where each sensor is adapted to produce an electrical signal when light impinges thereupon.

The said light sensing means preferably gives output in the form of pluro-stimulus values, where, the pluro-stimulus values are absolute values of red, blue and green color (RGB) and/or EF (extra frequency/frequencies) components with respect to given fixed light source.

Or alternatively the said light sensing means may also, either directly or after an internal conversion process, give output in the form of any other combination of wavelength components or any other known color standard like XYZ (X, Y, Z) color specification system, L*A*B* color specification system, Hunter's color specification system (L, A, and b values), L*C*h* color specification system (L* value, C* values and h* value) specified in CIE (1994) or Munsell color specification system.

Above-mentioned representation of light composition is of not much use to us as most of them are devised considering the human eye response. But here, in the present invented colorimeter, the light sensing element should have a cold and mechanical response to light frequencies, possibly altogether different as compared to human eye. We need a machine vision! In other words, we need absolute untainted values of the components of the transmitted/reflected light (R, G, B, UV, IR etc.) for color matching logic.

The said light sensing means produces an electrical signal, representative of the said colored solution, in digital or analogue form, and the said signal is conditioned using the signal conditioning unit so as to make it suitable to be fed/interfaced to the computer/CPU for processing.

Conditioning of the said signal includes one or more of the following operations of the known art: amplification, scaling, mapping, encoding, conversions between analogue and digital forms, or any other mathematical transformations.

The light sensing means may preferably be comprised of two-dimensional arrays of photo detectors. Each photo detector is adapted to produce an electrical signal when the light impinges thereupon. The magnitude of the signal is directly proportional to the intensity of the light, which strikes the photo detectors and the output is in the form of individual intensity values of red, green and blue (RGB) and/or EF components in the incident light.

The said light sensing means may be formed by sensors responsive to EF along with the sensors responsive to white light. This light sensing means can be a single sensor, wherein; the EF responsive component is embedded along with the RGB responsive sensor. Or a separate EF sensor can be placed such that the transmitted light is incident on EF as well white light sensor.

The said light sensing means may be comprised of a single photo detector or an array of photo detectors where each photo detector is adapted to produce an electrical signal in digital or analogue form when light impinges thereupon and each said electrical signal indicates the respective frequency component, and each said electrical signal is conditioned using the signal conditioning unit so as to make it suitable to be fed/interfaced to the computer/CPU for processing.

Any available sensor like charge-coupled device (CCD) or light dependant resistor, which gives information regarding intensity of each point in the image in terms of (RGB and/or EF) values, which may be in analogue or digital form, can be used.

If the light sensing means produces an analogue signal representative of the object or the dark image or the image of the light source, then the output is converted into desired digital format by using signal conditioner and analogue to digital converter, and thus creating an array of sensed wavelength component values and sent to the computer/processor for processing. Interface with computer is achieved via any communication port like USB, serial, fire-wire etc.

When the dark image is obtained and recorded, and the light source and the light sensing means is calibrated, the instrument displays the status as ‘ready’, and the status indicator LED 24 glows. The lid is then opened and the object (the test tube containing colored solution) is inserted in the sample-receiving chamber and the lid is closed. After the lid is closed, the CPU, in auto mode, detects this event of lid closure as a signal to start the process of obtaining the color signature of the sample, the light source is switched ON, the light sensing means receives the transmitted light through the object and outputs electrical signals representative of the intensity and quality of the transmitted light components and generates color data of red, blue and green and/or EF components in response to sensed light.

The light sensing means (sensor) produces an electrical signal indicative of the frequency components of the light transmitted from the said colored solution in digital or analogue form. The said signal is sent to the computer via a communication link (for example like USB, RS232 etc.). The said signal is conditioned so as to make it suitable to be fed/interfaced to the computer/processor for processing. The fed color data of red, blue and green and/or EF components depicts the two dimensional image of the test solution. This color data forms the final image. This final image is comprised of color data corresponding to each sensing element by the light sensing means. The sensing element may be a separate sensor like photo-diode or may be part of a single sensor like CCD. Each point of an image represented by a distinct pluro-stimulus value set is termed as pixel.

The correction to the final image is done by subtracting dark image from the final image to get a corrected image.

The RGB and/or EF values of each of the pixel in the corrected image are averaged out to get a single set of RGB and/or EF values denoted henceforth as Rₐ, Gₐ, Bₐ, UVₐ, IRₐ (color signature). The said color signature is then subsequently compared with the respective database/look-up table for the selected test substance.

Image recorded by the said sensing means may have the data of the colored compound and the data of the incident light. This may happen if the amount of the test sample (said colored solution) is small and the test tube is partially filled. And for this purpose, a software routine separates out the colored components of the image that depict the color signature of the solution from the background image of the light source. Here, the relative proportions of tristimulus values of white color of the pretest attuned light are already known to the software where R %, G %, B % of incident white light is constant and known. And hence if the image is composed of colored part of the colored solution and background white part, then the white color is easily identified due to its known relative proportions of RGB and only the colored part having RGB proportions dissimilar to white color is taken into account. Consequently, the computer/processor will accept the color data of the said solution and neglect the direct light incident on the sensor and thus won't affect the analysis.

Computational routines are basically the procedures executed by the CPU in order to carry out various processes like acquiring inputs from an operator and the sensor, calibration of light source and light sensing means, color matching logic (comparison logic), displaying, communication with external peripherals, etc. These computational routines are stored in the memory means.

Intended for convenience, for describing the color matching logic (comparison logic), we have considered in the following discussion the representative pluro-stimulus value set to be depicted by (RGB) value set, which is a subset of the pluro-stimulus value set. This also applies to the discussion of look-up table formation, wherein, in fact we store concentration and corresponding pluro-stimulus value set. It also applies as well to the regression analysis of the data in the concentration—pluro-stimulus value table described herein below.

Processing the data of the sensed wavelength component values—RGB color values of the color signature—involves a comparison between each component of the said color signature and each corresponding component of the various RGB data sets stored in a look-up table for the corresponding known substance being quantitatively analyzed. In other words, comparison of two sets of RGB values essentially means R of first set is compared with the R of second set, G of first set is compared with the G of second set and B of first set is compared with the B of second set, for their magnitude.

The RGB match if directly found indicates the concentration of the solution.

In case an exact match is not found among the stored values of the look up table, then the built-in software, based on standard interpolation techniques, carries out the required regression analysis for the sensed tristimulus value set (color signature of the said solution) and determines the exact concentration.

It is essentially assumed and used as a principle in the invented colorimeter that the concentration of a substance is a well-defined function of corresponding color values of red blue and green color. Thus, the three RBG colors form the independent variables and the concentration forms the dependent variable.

Note that the herein below given table-1 forms a set of discrete values of colors and the corresponding concentration. In actual practice, one may not match precisely a color signature of a colored solution with any of the data depicted in the look-up table and may not directly determine the concentration by looking into the look-up table. In this case one may get values for colors, which are intermediate or deviated here and there from the values recorded in the table.

To handle such a situation for determining the concentration for intermediate values, one can use the known methods of interpolation for interpolating the values of the concentration. Least square approximation is one such procedure. The regression analysis is carried out. The regression coefficients are determined. With the help of these coefficients, the approximation function f is obtained, which closely approximates the data of colors verses concentration. This function is determined by the action of minimizing of the sum of squares of deviations. This function is called the least square fit.

Let C=f(R,B,G), where C represents the concentration as a function of color values R, B, G. In a linear regression, the function f is assumed to have the following form:

f=A₀+A₁R+A₂B+A₃G, where A₀, A₁, A₂, A₃ are constants called the regression coefficients, obtained from the so-called normal equations arrived at by minimizing the metric S, which minimizes the sum of squares of deviations. This metric is defined as follows:
S=Σ(C−f)²
Depending on the variation type of the data one may require Polynomial Regression or regression by some other suitable functions like trigonometric or exponential functions etc. A well-established theory is available to carry out such tasks.

Depending upon the availability of the emitters that emit the frequencies higher and lower than the visible range and similarly the sensors which detect the frequencies higher and lower than the visible range (i.e. low frequency signals like infrared or still lower like microwave signals, or high frequency signals like ultraviolet signals) and depending upon the use of these low/high frequencies for which the emitters and sensors are available (or will be known through the future research), one can incorporate those extra frequencies for analysis based on color matching logic. One can easily make the appropriate changes in the equations used for interpolating the values of the concentration. Now, the function f will not be dependent only on R, B, G but more number of frequencies. For example: The concentration, C, will now be a function of color values R, B, G and I, U where I, U represent the infrared and ultraviolet colors values respectively. In a linear regression, the function f will now take the following form:
f=A₀+A₁R+A₂B+A₃G+A₄I+A₅U
where A₀, A₁, A₂, A₃, A₄, A₅ will be the constants called the regression coefficients, obtained from the so-called normal equations arrived at by minimizing the appropriately modified metric S, which minimizes the sum of squares of deviations. This metric is defined as follows:
S=Σ(C−f)²

In general, if there are k number of frequencies and S₁, S₂, . . . , Sₖ on which the concentration depends, i.e. let C=f (S₁, S₂, . . . , Sₖ), then, in a linear regression, the function f will now take the following form:

f=A₁S₁+A₁S₂+ . . . +AₖSₖ, where A₁, A₂ . . . , Aₖ are called the regression coefficients, obtained from the so-called normal equations arrived at by minimizing the appropriately modified metric S, which minimizes the sum of squares of deviations. This metric is defined as follows:
S=Σ(C−f)²

Depending on the various types of the data one may require Polynomial Regression or regression by some other suitable functions like trigonometric or exponential functions etc.

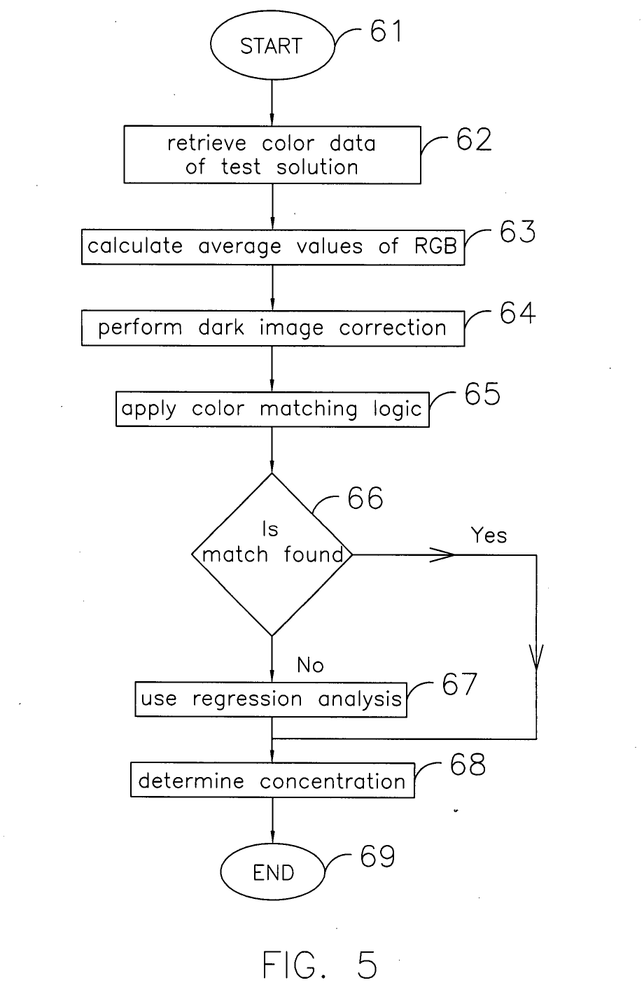

FIG. 5 is a flow chart depicting various steps of the color matching logic. Step 61 starts the color matching operation. Block 62 depicts retrieving the color data of the test solution. Average of RGB and/or EF values of all points in the image is calculated to get a single RGB and/or EF value set, which is to be matched (Block 63). Dark image correction is performed (Block 64). Step 65 denotes the comparison between each component of the RGB and/or EF values of the color signature and each component of the various RGB and/or EF data sets stored in the look-up table for the corresponding known substance being quantitatively analyzed. Decision diamond 66 checks whether a direct match is found. If no, regression analysis (block 67) is used and concentration is determined. Or if the decision diamond finds a direct match, concentration is directly determined (block 68). Step 69 denotes end of the color matching operation.

Selection of the mode of the operation is initially controlled by imputing the respective name/code name/mnemonic/kit manufacturer's name etc of the substance to be tested. This is done by inputting the relevant data by the keyboard 21. Display means 22 as shown in the FIG. 2, present on the front external surface, displays the keyed in input for counterchecking.

The chromaticity of the said solution to be quantitatively determined for a known substance is compared with the respective stored data. The stored color data of each substance, which could be tested, is stored in the form of look-up tables. This is inputted in the computer/processor memory subsequent to the prior study. This study is undertaken in the exact conditions, wherein, the intensity and quality of the incident light on the object, the reagents used, the quality of the test tube inserted in the sample receiving chamber and the type and quality of the sensors used for sensing the color data (RGB) is necessarily same.

As an example let us consider the way RGB color data for the test of blood glucose level is obtained and stored in the computer/processor memory. This tedious procedure is undertaken in the laboratory of the manufacturing company, which manufactures the calorimeter of present invention or the manufacture of the test kit for the blood glucose level test. Let us consider that the company decides to have the color data for 0 mg % to 650 mg % glucose (target range for glucose test) for storing in the memory of the instrument for comparison.

Each of these 651 standard samples is prepared by dissolving a defined amount of glucose in distilled water (DW). For example, standard sample (SS) No. 1 is prepared by dissolving 0 mg of glucose in 100 ml of DW. SS No. 2 is prepared by dissolving 1 mg of glucose in 100 ml of DW . . . SS no. 651 is prepared by dissolving 650 mg of glucose in 100 ml of DW.

Each of these standard samples is subjected to the defined test with the same test kit as is to be used for the test sample. Any standard sample thus prepared when subjected with the chemical reaction by the test kit reagents will form a colored compound. The intensity of the color formed is dependent on the concentration of the substance (glucose in the present case). The color signature of the colored solution related to each SS is found and the results obtained are entered in a tabular format.

TABLE 1
Color signature versus concentration:

| | Concentration of | | | | |
|---|---|---|---|---|---|
| SS No. | glucose | | R | G | B |
| 1 | 0 | mg % | x₁ | y₁ | z₁ |
| 2 | 1 | mg % | x₂ | y₂ | z₂ |
| . | . | | . | . | . |
| . | . | | . | . | . |
| . | . | | . | . | . |
| 651 | 650 | mg % | x₆₅₁ | y₆₅₁ | z₆₅₁ |

Thus each test that can be performed has a look-up table made up of RGB value triplets and the concentration corresponding to each triplet.

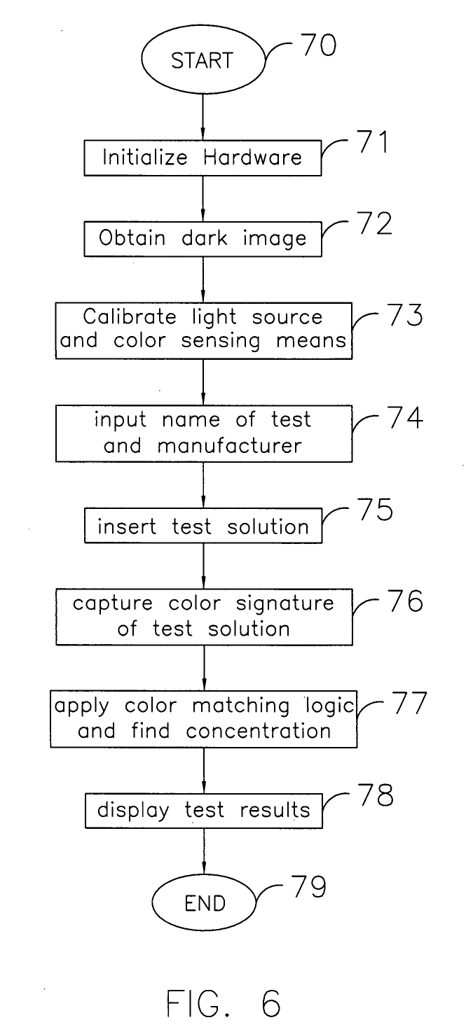

FIG. 6 depicts a flow chart of the operation of the instrument for quantitative determination of the known substance in a test sample. The colorimeter initially shows status as “NOT READY” where LED 24 does not glow. Step 70 denotes the start up of the invented instrument when one switches ON the start button. Step 71 depicts hardware initialization. Block 72 depicts obtaining dark image signature. Block 73 depicts calibration of the light source and the light sensing means. At the end of the hardware initialization and the calibration, the calorimeter shows status as “READY” by glowing LED 24. Step 74 denotes inputting name of the test and/or name of the manufacturer of the test kit. In step 75, the test solution in the test tube is inserted in the sample-receiving chamber. One has to open the lid covering the sample-receiving chamber and place the test-tube containing the test solution in the cavity and close the lid. Closing the lid starts the colorimetric operation (auto mode) or alternatively, the user can press the start/reset button (manual mode) and command the instrument to start operation. The user shall use appropriate keys of resetting and commanding for operation in desired mode. The software takes care of carrying out suitable actions considering the mode, settings and inputs. The RGB and/EF data of the test solution is sensed by the said sensor and is then inputted to the computing means. The image is a 2-dimensional array of pixel values, wherein each pixel is represented by a set of RGB and/EF values. This final image is then corrected by deducting the dark image from it. The color signature of the said colored solution is thus captured (step 76) and stored in the on-board memory. Color matching logic operation is then executed and analysis of the test solution for quantitative determination of the known substance in question is determined in step 77. If the RGB match is directly found, then the concentration of the solution is directly found and is then displayed. In case an exact match is not found among the stored values of the table of RGB values and the corresponding concentration of the substance in question, then the built-in software, based on standard interpolation techniques, carries out the required regression analysis and determines the exact concentration, which is then displayed. The test results are displayed (step 78). Step 79 depicts the end of the operation.

The said computing means (CPU or micro-controller or computer etc.) is used for performing the color matching logic operation and determining the concentration of the said colored solution. The obtained color signature for the said colored solution is used to select a pluro-stimulus value set from the corresponding look-up table which matches with it, and the concentration of related known substance is determined by looking-up the corresponding value of the concentration in the look-up table. When exact match is not found, in such case, the said computing means interpolates/extrapolates the color signature (the pluro-stimulus value set) using the array of corresponding look-up table pluro-stimulus values or by using the representative function formed using regression analysis, for determining the concentration of said known substance.

Finding the concentration of an enzyme in a test substance by using the present invented calorimeter:

Generally, concentration of enzymes is determined by adding a specific amount of the sample containing the enzyme or a treated sample containing the enzyme in a specific amount of substrate solution. The enzyme action on the substrate depends on the temperature and duration of time. Generally, the enzyme action is linear for certain duration of time (say after 1 minute up to 3 minutes since the start of reaction) at a given temperature. The present technique in the known art requires that reading be taken at exact time instant during the reaction. The calorimetric determination is mandatory at the end of that specific time. The technologists under pressure of workload, many a times, fail to take the colorimetric reading at the proper instant. This is bound to lead to an error.

The present invention suggests an inbuilt computational routine to avoid the above mentioned error and at the same time give a very accurate test result by automatically (software controlled) taking numerous readings within the prescribed period (linear phase of the reaction) and calculating a weighted average of the said readings to get the final accurate value of the concentration of the enzyme. Time dependency exists because of variation in chromaticity and/or intensity of the color of the test sample as the reaction proceeds. There exits, in the memory means, an already inputted set of time-dependent look-up tables for that particular enzyme test corresponding to predefined time intervals of the related enzyme action.

During the creation of the said set of look-up tables in a factory, for each known enzyme that can be quantitatively determined, a plurality of standard solutions are prepared in an orderly manner and having concentrations in the target range extending from zero to the highest possible expected value for that enzyme. Each of these standard samples is subjected to the defined test with the same test kit as is used for the test sample. While each of these standard samples are analyzed for their concentration, the readings are taken at predefined time instants like 1 minute, 1.5 minute, 2 minute, 2.5 minute and at 3 minute, wherein the linearity of the said enzyme action is from 1 to 3 minutes. Thus, for each above said interval the said time-dependent look-up table is formed, and stored in the memory means. And thus a set of five such time dependent look-up tables (considering the present case) is formed for each of the said standard samples and inputted in the memory means.

Preferably, the colorimeter is calibrated before taking each of the above said readings. During the analysis of an enzyme to find its concentration, care is taken, wherein the time instant, at which the reading is taken, is taken into account and the corresponding time-dependent look-up table is referenced to determine the concentration. And all such determined concentrations are used to calculate the average value of concentration (the weighted average).

The name of the enzyme to be tested quantitatively and the name of the kit manufacturer (if required) should be entered prior to the test using the keyboard. The colorimeter's illumination means and sensor are calibrated as usual before taking the readings.

As soon as the sample (containing the known enzyme to be quantitatively determined) is added in the substrate, the technologist shall signal the system by using the keyboard and shall insert the test tube containing the above test solution in the sample-receiving chamber (before the start of said prescribed period).

The computing means senses the color signature of the said solution at predefined intervals of time within the prescribed period for that enzyme and stores these pluro-stimulus values in the memory.

The concentration of the enzyme is determined by using the said color matching logic for each of the pluro-stimulus values wherein each value has a corresponding time stamp (in other words each value has a corresponding time quantity associated with it which is nothing but the time instant at which the reading is taken).

The concentration values thus obtained are used to determine a weighted average, which is the final concentration. The process of calculating weighted average thus makes the final concentration value independent of time.

Quality Control of the Test Kit

The standard solution supplied in the test kit is used for quality control and not for comparison!

In any calorimetric analysis, the amount of the color formed is proportional to the concentration of the substance. Similarly it depends on other conditions like time, temperature of heating or incubation. In prior art methods, for each test, it is obligatory to run a standard solution of known concentration for comparing the concentration of the unknown sample of that substance. The present invention avoids this wasteful use of costly reagents for running a standard for each test. Instead, the standard in the test kit is run only once and that too, just to assure the quality of the reagents!

Generally, in a laboratory, the tests are performed with the test kits, which are readily available in market. The test kits include reagent/reagents and a standard solution. There is always a possibility of faulty manufacture of the said reagents and standard solution, or possibility of decaying or decomposing or altering the said reagents and standard solution in handling, transport or storage.

In the present invention, quality control of the reagents and the standard solution of the freshly purchased test kit can be undertaken by using the standard solution included in that kit. The reliability of the reagents and the quality of the test results can be checked with the said standard solution supplied with the kit. This needs to be done one time only. For example, if a test kit of blood glucose test is freshly opened, and one needs to undertake the quality control, then one needs to run the test with the supplied standard solution of known concentration and find out the test result. If the test result matches with the known value of concentration of the said standard within an acceptable range of values (acceptable predefined tolerance limit) then one can confirm the validity of the test kit and undertake further testing of the test samples without a quality control dilemma.

Colorimeter of the present invention is an instrument for obtaining color signature of a colored solution of a known substance to be quantitatively determined by measuring its absolute red, blue and green color and/or EF values and comparing or interpolating them with the stored color data for that substance.

The use of the pre-calibrated look-up tables (factory calibration) is frowned upon as they are considered to lead to serious errors.

One becomes apprehensive for errors due to improper intensity of incident light. More particularly, such a mismatch in intensity of the light in a unit used at the manufacturing unit, wherein a look-up table is prepared, and in a unit used by an end user will surely lead to inaccurate results. This is because the intensity referenced to by the look-up table is not the same.

The present invention meticulously controls the quality and intensity of the light from the light source and ensures a match (within reasonable tolerance limits) between the quality and intensity of the light from the light source for each unit, whether used in preparing look-up tables, or used by an end user. The housing allows nil or only minimal of the stray light or ambient light. The light sensing means are of the same type for the instrument used in factory calibration and for each instrument used in a laboratory. A technologist can undertake quality control study by running the standard solution from a newly purchased test kit. The look-up tables can be inserted/updated through removable media (floppies, USB sticks, CD's etc.) or the internet in case of computer being used as processing unit or by EEPROM/FLASH memory update in case of microprocessor/microcontroller (on-board CPU) being used as processing unit.

### Description of the Second Embodiment

Another embodiment of the colorimeter operating on color matching logic incorporates reflection technique instead of the transmission one. Nonetheless, the embodiment uses the same premise of color matching logic for finding the concentration of a known substance (quantitative determination).

Here, an illumination means preferably providing white light and/or EF is enclosed in a guided light path to optimally illuminate the target/object (a colored solution) to be analyzed. The orientation of the enclosure is chosen to optimize the uniformity and intensity of the illumination of the target and to have optimal reflected light on the light sensing means. The angle of the reflection conceived for the enclosure can be chosen by one of ordinary skill in the art to optimize the uniformity and intensity of the illumination of the target and to have optimal reflected light on the light sensing means. The light emitter is preferably equipped with a collimation means.

The object under discussion is a test tube containing a colored sample, which is to be tested for its color signature. This object reflects light as a response to the incident light from the illumination means, and hence, the object acts as a secondary source of light. It is a well-known fact that light from any kind of light source (primary or secondary) has a tendency to diverge and hence spread over a large surface area. Considering this contention, it is advantageous to have a path for the reflected light to travel in a conical shape with final incidence on a broad light sensing means. The term broad light sensing means implies a larger color sensing surface area and hence better resolution. This is complimentary to the available larger base area of the inner conical structure in the present embodiment.

In another embodiment, the light sensing means senses the reflected light from the sample in another way. The emitted light from the light source and the reflected light from the object are guided by a light guiding means like fiber-optic tube. It is used between a light source and the object for giving a parallel light as a wave-guide and for avoiding the ambient light. Similarly it is used between the object and the light sensing means for giving a parallel light as a wave-guide and for avoiding the ambient light.

A collecting optical system can also be used for collecting the reflected light and is coupled optically to an end part of a receiving fiber optic cluster connecting the collecting optical system to the light sensing means, to which the receiving fiber optic cluster is coupled by its second end.

Or a plurality of special laser sensing photo-diodes can also measure the reflected light to get the pluro-stimulus values. To facilitate the color measurement, the light sensor may also include a telephoto lens.

As an example, one embodiment consists of a pair of concentric truncated conical structures (truncation being done at the apex) with their bases in the same plane. The inner conical structure has its truncated end in a plane, which is inside the body of the outer conical structure. Light emitted from the illumination means is contained within outer chamber (space between the outer and inner conical structure which allows the light beam to fall on the object) and may preferably have total internal reflection (TIR). It guides the light to illuminate the target.

The illumination sources are placed uniformly over the base ring (which is the annular part of the base of the outer chamber). Preferably red, green and blue light emitters and/or EF emitters or white light or other appropriate basic colors combined to give white light, suitable for color measurement are placed over the base ring. Infrared or UV laser diodes can also be used in the said calorimeter to extend the frequency spectrum. The illumination means preferably includes a light source giving white light and/or EF lights of known quality and intensity. Laser diodes can maintain focused beams over greater distances, and that is why lasers are preferable.

Here, in the conical structure, the orientation of light projectors has a converging orientation. This is implicitly needed, as the reflected light from the object is to be sensed by a broad light sensing means and this conical structure is suitable for availing such reflection.

The object under discussion is a test tube containing a colored sample, which is to be tested for its color signature.

The said illumination means, in another embodiment, can have multiple uniformly aligned light emitters (R+G+B+IR+UV) that emit light onto the sample, either one at a time or collectively. In case of individual sampling with single color, the absolute value of the reflected color is recorded. Such individual measurements are finally combined, to form a color measurement set, to be used in the color matching logic.

Light reflected off the test solution, the wavelengths of which indicates the sample's color data, is sensed by a light sensing means and sent to the computing means for determining the color signature of the said color solution and subsequently for comparison with a predetermined color-data in a lookup table exactly in the same way as described in the preferred embodiment hereinbefore.

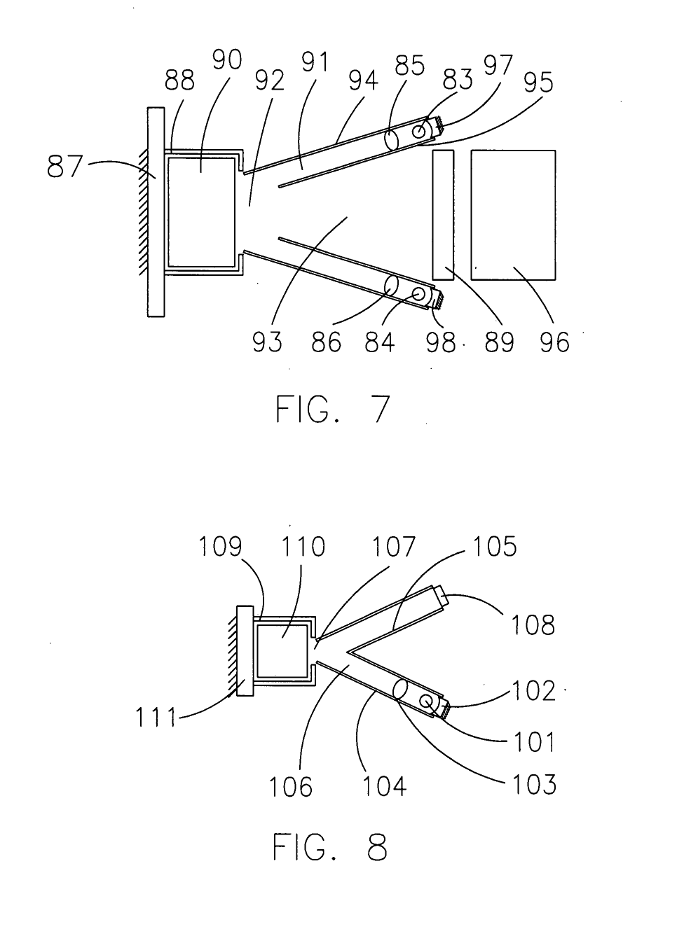

FIG. 7 and FIG. 8 are diagrammatic depictions of different possible optic assemblies designed for the second embodiment. Illumination assembly in FIG. 7 is enclosed within a conical enclosure as shown in the diagram (a vertical cut section of the functional part of the embodiment), wherein the light converges upon the object. It includes a light pipe 91 (or a fiber optic system for collection of light). The outer conical structure 94 has a shape of a truncated cone with an opening at the tapering end. The object 90 is placed at juxtaposition to this tapering illumination end 92. A mirror 87 is placed on the other side of the object as shown in the FIG. 7, which is useful for calibration of the illumination means. Concave mirrors 97 and 98 depict augmentation of the illumination means and convex lenses 85 and 86 depict collimation purpose.

Light sensing means 89 is fitted into the broader end of the inner truncated cone, which is concentric with the outer conical structure and has its truncated part in a plane inside the body of the outer conical structure as shown in the diagram 7. Illumination means 83 and 84 are abutted to, or imbedded in the broader end of outer conical structure peripherally on the basal part, which provides adequate space for the placement of illumination means and the said concentric conical structure also guides the emitted light to illuminate the target (object). Illumination means and light sensing means are connected to CPU. Block 96 schematically depicts the signal conditioning unit, CPU and memory block taken together. Illumination surface of the object may be convex (in case a round test tube is used) with a smooth reflecting surface or preferably a plain surface (when a square or rectangular test tube is used).

Light emitted from illumination means is contained within light path 91 which may preferably have total internal reflection (TIR) and guides the light to illuminate the target. The tip of the outer conical structure is placed at juxtaposition with the object. Light reflected from the target passes through the internal bore 93 of the inner conical structure 95 to the light sensing means 89. The length and diameter of bore are chosen to prevent specular reflections from the target from reaching the sensing means. The inner surface of outer conical structure and outer surface of inner conical structure may be coated with anti-reflecting material to prevent spurious reflection while the incident light is on its way towards the object. Similarly, the inner surface of inner conical structure may preferably be coated with anti-reflecting material to prevent spurious reflection while the reflected light is on its way towards the light sensing means.

The tip of the outer cone may comprise of a sleeve to facilitate tight contact with the target surface (Surface of the object) and preferably does not impede with the light path. Materials like vinyl or rubber are preferred for this purpose to facilitate fairly tight contact with the target surface. In operation, the cone's tip is automatically placed against the target when the test tube is inserted. As the target 90 is illuminated, the reflected light is captured by the sensor, which produces an electrical signal representing the intensity and quality of the reflected light.

The light from the light source is transmitted preferably through a lens for collimation purpose. The said lenses 85 and 86 as shown in the FIG. 7 are positioned such that the light source is at the focal point of the lens, which directs the light beam in a parallel fashion incident on the object. The said lenses for collimation purpose are aligned between the light source and the sample-receiving chamber 88. The light sources of the said illumination means are positioned at the focus of the said lenses so that a parallel light is produced on the other side of the lens to be made incident on the colored solution (object 90). Use of the lens is optional.

In another embodiment, as shown in FIG. 8, the illumination means 101 is placed and positioned such that the incident light, passing through the path 106 and falling on the object 110, is at a suitable angle with a (virtual) line perpendicular to the surface 107 of the object, which is in the same plane as the illumination means and the point of incidence on the object. The light sensing means 108 is positioned such that the reflected light is incident perpendicularly on its surface. The light sensing means is preferably broader. Each of the illumination means and the light sensing means are placed inside an enclosure 104 and 105 respectively, which is used to guide the incident and the reflected light in a guided direction (as shown in FIG. 8). The arrangement shown in the FIG. 8 shows that proper partitioning is done between the illumination means and light sensing means to avoid direct incidence of light from the illumination means. The object is placed in an enclosure 109, which does not intercept the path of incident and reflected light. A mirror 111 is placed on the other side of the object as shown in the FIG. 8, which is useful for calibration of the illumination means. A concave mirror 102 for augmentation of the illumination means and a convex lens 103 for collimation purpose may be used.

Power supply, which is either a battery supply or an adapter, is connected to the said colorimeter to provide electrical power. Alternatively an internal power supply circuitry to condition the external power input may be used.

The substance being quantitatively determined is invariably converted into a colored solution through respective specific chemical reaction/reactions.

The illumination means is employed to illuminate the object. The said object is preferably a square test tube containing a colored solution of a known substance to be quantitatively determined and placed in the sample-receiving chamber. The round variant of the test tube can also be used. Object 110 is to be inserted in the sample-receiving chamber 109. The incident light of the illumination means is reflected by the object, which in turn falls on the light sensing means 108.

Here, in this second embodiment, the use of the reflection technique is the only difference. The rest of the components and their functions are more or less same and thus they are not described in detail.

There are some minor differences in this embodiment.

The light incident on the light sensing means is reflected light instead of transmitted one

The CPU controls the voltage output from the current control block through a feedback mechanism to achieve the desired defined output of the illumination means. Here, during the pre-test current control mechanism and at the time of the sample testing, the light sensing means receives the reflected light instead of transmitted one.

Similarly, while testing the sample, the said light sensing means receives the reflected light (reflected from the sample) and outputs electrical signals (digital or analogue form) representative of the intensity of the reflected light components and generates absolute color data of red, blue and green color and/or EF components (color signature of the said colored solution) in response to sensed light. The signal is conditioned (amplified and digitalized) so as to make it suitable to be fed/interfaced to the computer/processor for processing. The procedure of testing, the process of the color matching logic and the necessary components and paraphernalia in the instrument are similar as in the previous embodiment.

### Description of the Third Embodiment

Flame photometry, as described extensively in the prior art, more or less, works on the same principle as that of conventional photoelectric colorimeter.

When atoms of some elements are introduced into a non-luminous flame, they emit light of specific wavelengths characteristic of that element. For example salts of sodium when introduced into a flame of a Bunsen burner give out yellow light. This happens because the thermal energy of the flame causes higher internal energy level (excited state) in the atoms of that element and subsequently they spontaneously revert to the normal energy level producing emission of light at a characteristic wavelength (for example for sodium at about 590 nm). The amount of the emission of the light is generally proportional to the amount of the element in the flame. The amount of light emitted also varies with the amount of the thermal energy available. In other words, the amount of emitted light is also dependent on the flame temperature.

Thus, in a flame photometer, a solution of an element to be tested quantitatively is aspirated into the flame at a constant rate so that its inputted amount in the flame is kept constant. The amount of the emitted light is proportional to the concentration of that element in that solution.

In a flame photometer, all the variables are carefully controlled. The flame temperature is kept as constant as possible. The aspirated solution for testing is also carefully regulated and kept constant. In prior art, the intensity of the light is measured by a photocell/photodiode as in conventional colorimeter and the concentration of the sample solution is calculated with comparison to the light emitted when a standard solution is aspirated in place of the sample.

The third embodiment of the present invention comprises of a component having a facility for accomplishing color-matching logic. The said embodiment is designed to provide as a component for substituting a photocell/photodiode used in the conventional flame-photometer. The said component also includes a facility for accomplishing color-matching logic. Though the remaining construction of the flame photometer needs to be configured in a more or less known manner, a little modification is advisable. Either the modification is accomplished or preferably an entire embodiment is manufactured as mentioned herein below for the laboratory use.

The modified flame-photometer consists of a flame producing means that is used as an illumination means. The flame temperature is kept as constant as possible. Similarly the flame illumination is kept at a predetermined RGB composition by a flame control block. A combustible gas input to the said flame is controlled via the flame control block. Here, the flame control block may employ various types of valves, which regulate the flow of combustible gas. The valve may be controlled through a servomechanism or fluid amplifier. The CPU commands the flame control block through a feedback mechanism. The gas input to the flame is controlled such that the desired defined RGB components of the illumination of the said flame in the pre-testing stage is achieved. The CPU determines the required variation in the input of the said gas through a feedback mechanism.

In the present invention, a flame producing means, a flame igniting means, a connecting means for connecting the tubing to the sample solution for aspiration in the flame, an aspiration means for aspirating the sample wherein the flow of the aspirated sample for testing is carefully regulated so that its inputted amount in the flame is kept as constant as possible. This is designed in the known manner and as such does not present any novelty.

A light sensing means to sense the color signature of the said flame is positioned at the place where the photocell/photodiode is located in the conventional flame photometer. The said light sensing means is designed to sense the color signature of the flame or the colored flame. The said colored flame is formed as a result of aspiration of the sample. The test is done for quantitatively determining a known element in a test sample. A microprocessor or a computer is coupled to the said light sensing means. Similarly a memory means is also coupled with the said microprocessor or the said computer for storing calibration commands, computational routines and comparison logic and for storing a plurality of color data corresponding to each element that can possibly be quantitatively determined by the said flame photometer and the said data is stored in the form of look-up tables.

The ‘combustible gas’ input to the said flame is controlled via the flame control block, wherein, the CPU commands the flame control block for controlling the intensity of RGB and/or EF components of the illumination of the said flame in the pre-testing stage. The said CPU determines the required variation in the input of the said gas through a feedback mechanism. The feedback signals comprise of RGB and/or EF sensed by light sensing means (dark image and pretest flame image) and the stored values of desired defined RGB and/or EF values. The temperature of the flame is controlled by using a known specific combustible gas for creating the look-up tables as well as by the end user. The temperature of a given gas remains the same and is generally independent of the amount of gas burnt. This keeps the temperature in a required range.

The CPU commands the flame control block for controlling the intensity of RGB and/or EF components of the illumination of the said flame in the pre-testing phase. A pre-test dark image and a flame image (source image) is obtained by the sensor as described hereinbefore in the preferred embodiment and inputted to the computing means. The computing means determines the corrected source image. The desired defined output for the said source is stored in the memory means of the microcontroller/computer. The combustible gas output to the flame is controlled by the computing means via analog/digital input to the flame control block for controlling the RGB and/or EF components of the flame. The computing means determines the required variation in the analog/digital input through a feedback mechanism.

The said feedback mechanism composes:

First feedback means wherein the sensor inputs the said dark image and the said source image to the computing means. Second feedback means wherein the memory means inputs the stored RGB and/or EF values of the desired defined output by the flame to the computing means and the computing means weighs them against the said corrected source image.

The computing means determines the mode of attunement of the flame. Here, the combustible gas input is either increased or decreased for attaining the effective desired defined light output by the flame.

The cycle of the feedback input to the computing means and the computing means varying the combustible gas input appropriately is continued till the ultimate permissible/tolerable intensity and quality of RGB and/or EF composition of the flame is achieved.

Switches are coupled to the said microprocessor or the said computer wherein they are used for switching ON the instrument, or for resetting, or for commanding the instrument for operations in various modes.

A display means is included for displaying the test results.

The functioning of the flame photometer for determining concentrations of elements like sodium, potassium, lithium etc. in a test sample is further discussed herein below.

The conventional prior art method in flame photometry uses a photocell/photodiode for measurement of the emitted colored light. The intensity and quality of the emitted colored light is proportional to the concentration of the element in a solution that is being aspirated in the flame.

The present invention uses a light sensing means like a CCD image sensor instead of a photocell/photodiode and the color matching technique as defined hereinbefore. The memory means stores look-up tables of quantitative test data for each of the plurality of known elements that can be quantitatively determined. Here, for each known element that can be quantitatively determined by the flame photometry, a plurality of standard solutions are prepared in an orderly manner and having concentrations in the target range extending from zero to the highest possible expected value. Each said standard solution is treated with exactly the same processing as is to be carried out for the processing of the corresponding known element in a test sample. A color signature for each said standard solution is obtained by the invented modified flame photometer. Here, the quality of the flame is kept controlled, the flow of the aspirated solution in the flame is carefully regulated and the quality of the light sensing means is maintained uniform in the unit used for creating the look-up table and in each manufactured unit.

The data representing the color signatures recorded for each said plurality of standard solutions is tabulated in the form of look up tables. A look up table is formed for each said element. Each of the RGB and/or EF pluro-stimulus value set of the said color signature is tabulated with the concentration corresponding to that set. The plurality RGB and/or EF pluro-stimulus value sets obtained from plurality of corresponding standard solutions of each element are tabulated in regularly graded concentrations. Thus a look-up table is formed for each element.

The said look-up tables stored in the said memory means can be inserted/updated through removable media (floppies, USB sticks, CD's etc.) or the internet in case of computer being used as processing unit or by EEPROM/FLASH memory update in case of microprocessor/microcontroller (on-board CPU) being used as processing unit.

Here, in a flame photometer, there is no illumination means, and instead of the transmitted/reflected light, a flame acts as the source of incident light. This is the only difference. The flame photometer comprises of a flame producing means (where the flame temperature is kept as constant as possible), an aspiration means for aspirating the sample solution where the aspirated solution for testing is carefully regulated and kept constant, a connecting means for connecting the tubing to the sample solution for aspiration in the flame, a flame igniting means and a lens to collimate the emitted light (use of the lens is optional). The light sensing means like CCD image sensor is used to sense the dark image, the pre-test flame image and the color signature of the colored flame. The said colored flame is formed as a result of aspiration of the said sample solution to be quantitatively determined for a known element. The known element is then quantitatively determined using the color matching logic as described hereinbefore in the preferred embodiment.

The case of the housing is preferably so designed as to cover the entire functional instrument and no ambient light or stray light is allowed to enter. The housing also provides for the air supply inlet and exhaust outlet without letting any ambient light to intrude inside. As an example, one can use an inlet-curved tube and an outlet curved tube, which are designed such that light cannot directly enter the housing. Similarly, if the interior of the tubes is blackened, there is hardly any reflection of the light, and hence the light would not enter the housing.

The above description thus indicates certain embodiments of the present invention, and it is apparent to those expert and skilled in the art that numerous versions and modifications may be made without departing from the scope of the present invention.

We claim:

1) A colorimeter operating on color matching logic for quantitatively determining a colored solution for a known substance, said colorimeter comprising:
a housing;
an illumination means to illuminate the object (the colored solution) to be analyzed;
a sample-receiving chamber for positioning the said colored solution in a test tube, positioned between the illumination means and light sensing means;
a light sensing means for receiving the transmitted light and outputting electrical signals representative of the quality and intensity of the transmitted light components in response to sensed light;
input means for inputting the name of the known substance to be tested quantitatively and the name of the manufacturer of the test kit used for that test;
a computing means coupled to the said light sensing means;
a memory means coupled with the said computing means for storing calibration commands, computational routines and comparison logic and for storing a plurality of color data corresponding to each biochemical, clinical pathological or chemical test for the substances that can possibly be quantitatively determined by the said calorimeter and the said data is stored in the form of look-up tables;
the said computing means for performing the color matching logic operation and determining the concentration of the said colored solution;
switches coupled to the said computing means wherein the said switches are used for switching ON the instrument, resetting, and commanding the instrument for operations in various modes;
a display means for displaying the test results.

2) A colorimeter operating on color matching logic as claimed in claim 1, wherein a closed loop control mechanism is used to keep the quality and intensity of the light source of the said illumination means at predetermined defined values, the said mechanism comprising:
the light sensing means to obtain a dark image and a source image;
the computing means to determine the corrected source image;
the desired defined output of the source is stored in the memory means of the computing means;
the voltage output from the current control block to the illumination means is controlled by the computing means via analog/digital input to the current control block for controlling the RGB and/or EF components of the illumination means, and wherein the said computing means determines the required variation in the analog/digital input depending on the feedback signals obtained from the light sensing means and the memory means;
the light sensing means inputs the said dark image and the said source image to the computing means;
the memory means inputs the stored RGB and/or EF values of the desired defined output of the illumination means to the computing means and the computing means weighing them against the corrected source image;
the computing means determines the mode of attunement, where either increase or decrease of voltage is accomplished, and wherein the said computing means modifies the voltage/current output accordingly to the illumination means through the current control block for attaining the effective desired defined light output;
the cycle of the feedback input to the computing means and the computing means varying the voltage output appropriately is continued till the ultimate permissible/tolerable intensity and quality of RGB and/or EF composition of the illumination means is achieved.

3) A colorimeter operating on color matching logic as claimed in claim 1, wherein the said memory means stores look-up tables of quantitative test data for each of the plurality of known substances that can be quantitatively determined, the said look up tables are formulated by:
for each known substance that can be quantitatively determined, a plurality of standard solutions are prepared in an orderly manner and having concentrations in the target range extending from zero to the highest possible expected value;
each said standard solution is treated with exactly the same processing as is to be carried out for the processing of the corresponding known substance in a test sample so as to obtain a colored solution;
a color signature for each said colored solution is obtained by the invented calorimeter wherein the quality and intensity of the incident light, the quality, size and shape of the test tube holding the colored solution and quality of the light sensing means is almost same as is to be applied for the test sample;
the data representing the color signatures recorded for each said plurality of standard solutions is tabulated in the form of look up tables, where a look up table is formed for each said substance, and wherein each of the RGB and/or EF pluro-stimulus value set of the said color signature is tabulated with the concentration corresponding to that set and where the plurality RGB and/or EF pluro-stimulus value sets obtained from plurality of corresponding standard solutions of that substance are tabulated in regularly graded concentrations;
the said look-up tables stored in the said memory means can be inserted/updated through removable media like floppies, USB sticks, CD's etc. or through the internet in case of computer being used as processing unit or by EEPROM/FLASH memory update in case of microprocessor/microcontroller/on-board CPU being used as processing unit.

4) A calorimeter operating on color matching logic as claimed in claim 1, wherein the illumination means preferably comprises:
a light source giving white light of known quality and intensity, or comprised of red, green and blue lights or other appropriate basic colors combined to give white light; or red, green and blue light sources along with or completely replaced by sources emitting extra frequencies like ultra violet, infra-red etc., and wherein the said sources are capable of giving electromagnetic frequencies of variable quality and intensity, and wherein the said sources are light emitting diodes or laser sources or halogen lamps or neon lamps or xenon lamps or light bulbs.

5) A colorimeter operating on color matching logic as claimed in claim 1, wherein the said illumination means includes a lens for collimation purpose aligned between the light source and the sample receiving chamber and wherein the illumination means is positioned at its focus so that the parallel light is produced on the other side of the lens to be made incident on the said colored solution.

6) A colorimeter operating on color matching logic as claimed in claim 1, wherein the said light sensing means receives the transmitted light and outputs electrical signals in digital or analogue form representative of the intensity of the transmitted light components and generates absolute color data of red, blue and green color components and/or EF components in response to sensed light, and wherein the said signal is conditioned (amplified and digitalized) so as to make it suitable to be fed/interfaced to the computer/processor for processing, and wherein the said light sensing means may be comprised of array of sensors where each sensor is adapted to produce an electrical signal when light impinges thereupon and wherein the said sensors may be comprised of array of photo detectors where each photo detector is adapted to produce a proportional electrical signal when light impinges thereupon.

7) A calorimeter operating on color matching logic as claimed in claim 1, wherein finding the concentration of a test substance comprises of the following steps:
a) the name/mnemonic of the said test and/or the name/mnemonic of the manufacturer of test kit is entered using keyboard prior to the start of colorimetric operation;
b) the colorimeter is calibrated;
c) the sample which has developed a colored compound through the chemical reaction or through a series of chemical reactions is placed in the sample receiving chamber;
d) the calorimeter is signaled;
e) the computing means acquires the image of the test solution, computes the color signature and stores the related pluro-stimulus values in the memory;
f) the said computing means performs the color matching logic operation and determines the concentration of the said colored solution;
g) the display means displays the said concentration.

8) A colorimeter operating on color matching logic as claimed in claim 1, wherein, if the color data recorded by the sensor has the data of the colored solution and the data of the incident light as a result of the amount of the said colored solution being small and the test tube being partially filled, a software routine separates out the components of the image which depict the color signature of the solution from the background of the source image, and wherein the said separation comprises of steps:
the tristimulus values of the said background RGB colors are stored in memory means as the source image;
the computing means neglects the said source image and accepts the color data of the said colored solution for color matching logic, wherein the said color data represents the color signature of the said solution having RGB component values dissimilar to the said source image.

9) A colorimeter operating on color matching logic as claimed in claim 1, wherein the said look-up tables could be redefined, the said redefinition comprises:
if one or more of the source components of illumination means are inherently defective resulting into a permanent offset in one or more of the frequency components, the said frequency components, which are deviated from the said desired value are chosen and the values of the corresponding component in the look-up table are redefined by adding/subtracting the deviated amount so that the table gets adjusted in a linear way;
if one or more of the source components of illumination means are inherently defective resulting into a permanent offset in one or more of the frequency components, and if the absorption of the light component/components is not linearly proportional to the concentration of the colored solution, the redefinition of the offsets (Rₛ˜R_{f}) and/or (Gₛ˜G_{f}) and/or (Bₛ˜B_{f}) for the said frequency component/components is done by considering the absorption characteristics;
if the temperature related guidelines of a test are not followed and the temperature of the test colored solution is inappropriate, and if there is a significant mismatch in the temperature of the said solution as per guidelines, then this difference in temperature is used to redefine the look-up table values for each of the frequency components considering the temperature characteristics for that particular test, wherein the said temperature characteristics for that particular test are derived by analysis of the data acquired from the experiments carried out at different reference temperatures and the said data is used to re-establish the relationship between the pluro-stimulus values and the corresponding concentration for the corresponding temperature.

10) A colorimeter operating on color matching logic as claimed in claim 1, wherein finding the concentration of an enzyme in a test sample comprises of the following steps:
a) the name/mnemonic of the test and/or the name/mnemonic of the manufacturer of test kit is entered using keyboard;
b) as soon as the predefined amount of the sample, containing a known enzyme to be quantitatively determined, is added in the predefined amount of substrate to form a test solution, the colorimeter is signaled and the test tube containing the said test solution is inserted in the sample receiving chamber;
c) the computing means automatically takes numerous readings within the linear phase of the reaction for that enzyme, wherein, it senses the color signature of the said solution at predefined intervals of time, stores these sets of plurostimulus values in the memory and calculates a weighted average of the said readings to get the final accurate value of the concentration of the enzyme.

11) A colorimeter operating on color matching logic as claimed in claim 1, wherein the concentration of a known substance is determined using color matching logic, where the said color matching logic implies:
selecting a pluro-stimulus value set from the related look-up table which matches with the color signature of the said colored solution and in such case determining the concentration of the known substance by looking-up the corresponding value of the concentration in the look-up table; or when exact match is not found, in such case, interpolating the color signature by regression analysis for determining the concentration of said known substance.

12) A colorimeter operating on color matching logic using reflection technique for quantitatively analyzing a colored solution of a known substance, said calorimeter comprising:
a housing;
an illumination means enclosed in a guided light path to optimally illuminate the colored solution to be analyzed and wherein the enclosure is chosen to optimize the uniformity and intensity of the reflected light on the light sensing means;
a sample-receiving chamber, situated between the illumination means and the mirror, for positioning the said colored solution;
a light sensing means located for optimally receiving the reflected light from the mirror or the colored solution and for outputting electrical signals representative of the quality and intensity of the reflected light components in response to sensed light;
input means for inputting the name of the known substance to be tested quantitatively and the name of the manufacturer of the test kit used for that test;
a computing means coupled to the said light sensing means;
a memory means coupled with the said computing means for storing calibration commands, computational routines and comparison logic and for storing a plurality of color data corresponding to each biochemical, clinical pathological or chemical test for the substances that can possibly be quantitatively determined by the said calorimeter and the said data is stored in the form of look-up tables;
the said computing means performing the color matching logic operation and determining the concentration of the said colored solution;
switches coupled to the said computing means wherein the said switches are used for switching ON the instrument, resetting, and commanding the instrument for operations in various modes;
a display means for displaying the test results.

13) A colorimeter operating on color matching logic as claimed in claim 12, wherein a closed loop control mechanism is used to keep the quality and intensity of the light source of the said illumination means at predetermined defined values, the said mechanism comprising:
a dark image and a source image is obtained by the sensor and inputted to the computing means;
the computing means determines the corrected source image;
the desired defined output of the said illumination means is stored in the memory means;
the voltage output from the current control block to the illumination means is controlled by the computing means via analog/digital input to the current control block for controlling the RGB and/or EF components of the illumination means, and wherein the said computing means determines the required variation in the analog/digital input depending on the feedback signals obtained from the light sensing means and the memory means, the said feedback mechanism composing:
the light sensing means inputs the said dark image and the said source image to the computing means;
the memory means inputs the stored RGB and/or EF values of the desired defined output of the illumination means to the computing means and the computing means weighing them against the corrected source image;
the computing means determines the mode of attunement where either increase or decrease of voltage to the illumination means is to be accomplished, and wherein the said computing means modifies the voltage/current output accordingly through the current control block for attaining the effective desired defined light output;
the cycle of the feedback input to the computing means and the computing means varying the voltage output appropriately is continued till the ultimate permissible/tolerable intensity and quality of RGB and/or EF composition of the illumination means is achieved.

14) A colorimeter operating on color matching logic as claimed in claim 12, wherein the said light sensing means receives the reflected light and outputs electrical signals in digital or analogue form representative of the intensity of the reflected light components and generates absolute color data of red, blue and green color components and/or EF components in response to the sensed light, and wherein the said signal is conditioned so as to make it suitable to be fed/interfaced to the computing means for processing, and wherein the said light sensing means may be comprised of array of sensors where each sensor is adapted to produce an electrical signal when light impinges thereupon and wherein the said sensors may be comprised of array of photo detectors where each photo detector is adapted to produce a proportional electrical signal when light impinges thereupon.

15) A colorimeter operating on color matching logic as claimed in claim 12, wherein, if the data received by the sensor has the data of the colored solution and the data of the incident light as a result of the amount of the said colored solution being small and the test tube being partially filled, a software routine separates out the colored components of the image which depict the color signature of the said solution from the image of the light source, and wherein the said separation comprises of steps:
the tristimulus values of the said background RGB colors are stored in memory means as the source image;
the computing means neglects the said source image and accepts the color data of the said colored solution for color matching logic, wherein the said color data represents the color signature of the said solution having RGB component values dissimilar to the said source image.

16) A calorimeter operating on color matching logic as claimed in claim 12, wherein the said memory means stores look-up tables of quantitative test data for each of the plurality of known substances that can be quantitatively determined, the said look up tables are formulated by:
for each known substance that can be quantitatively determined, a plurality of standard solutions are prepared in an orderly manner and having concentrations in the target range extending from zero to the highest possible expected value;
each said standard solution is treated with exactly the same processing as is to be carried out for the processing of the corresponding known substance in a test sample so as to obtain a colored solution;
a color signature for each said colored solution is obtained by the invented colorimeter wherein the quality and intensity of the incident light, the quality, size and shape of the test tube holding the colored solution and quality of the light sensing means is almost same as is to be applied for the test sample;
the data representing the frequency values of red, blue and green color and/or extra frequency/frequencies recorded for each said plurality of standard solutions is tabulated in the form of look up tables, wherein a look up table is formed for each said substance and where each of the said RGB and/or extra frequency/frequencies pluro-stimulus value set is tabulated with the concentration corresponding to that set and where the plurality RGB and/or extra frequency/frequencies pluro-stimulus value sets obtained from plurality of corresponding standard solutions of that substance are tabulated in regularly graded concentrations;
the said look-up tables stored in the said memory means can be inserted/updated through removable media like floppies, USB sticks, CD's etc. or the internet in case of computer being used as processing unit or by EEPROM/FLASH memory update in case of microprocessor/microcontroller/on-board CPU being used as processing unit.

17) A colorimeter operating on color matching logic as claimed in claim 12, wherein finding the concentration of an enzyme in a test sample comprises of the following steps:
a) the name/mnemonic of the test and/or the name/mnemonic of the manufacturer of test kit is entered;
b) as soon as the predefined amount of the test sample containing a known enzyme to be quantitatively determined is added in the predefined amount of substrate to form a test solution, the calorimeter is signaled and the test tube containing the said test solution is inserted in the sample receiving chamber;
c) the computing means automatically takes numerous readings within the linear phase of the reaction for that enzyme, wherein, it senses the color signature of the said solution at predefined intervals of time, stores these sets of plurostimulus values in the memory and calculates a weighted average of the said readings to get the final accurate value of the concentration of the enzyme.

18) A calorimeter operating on color matching logic as claimed in claim 12, wherein the illumination means preferably comprises:
a light source giving white light of known quality and intensity, or comprised of red, green and blue lights, or other appropriate basic colors combined to give white light, or red, green and blue light sources along with or completely replaced by sources emitting extra frequencies like ultra violet, infra-red etc., and wherein the said sources are capable of giving electromagnetic frequencies of variable quality and intensity, and wherein the said sources are light emitting diodes or laser sources or halogen lamps or neon lamps or xenon lamps or light bulbs.

19) An independent unit accomplishing color matching logic for substituting a photocell/photodiode to be used in the modified conventional flame-photometer for quantitatively determining the concentration of a known element, the said modified flame-photometer comprising:
a housing;
a flame producing means, used as an illumination means, and where the flame temperature is kept as constant as possible;
a connecting means for connecting the tubing to the test solution for aspiration in the flame;
an aspiration means for aspirating the said solution to be quantitatively determined for the said known element, wherein, the flow of the aspirated solution in the flame is carefully regulated so that its inputted amount in the flame is kept as constant as possible;
a flame igniting means;
a lens to collimate the emitted light;
a light sensing means to sense the color signature of the said flame;
the said light sensing means to sense the dark image or the color signature of the pretest flame or the colored flame formed as a result of aspiration of the said solution;
a computing means coupled to the said light sensing means;
a memory means coupled with the said computing means for storing calibration commands, computational routines and comparison logic and for storing a plurality of color data corresponding to each of the elements that can possibly be quantitatively determined by the said flame photometer and the said data is stored in the form of look-up tables;
a flame control block for controlling the combustible gas flow output to the said flame, wherein, the computing means commands the flame control block for controlling and attuning the RGB and/or extra frequency/frequencies components of the illumination of the said flame in the pre-testing stage to achieve the desired defined quality and intensity of illumination and temperature, and wherein the said computing means determining the required variation in the flow output of the said gas through a feedback mechanism;
the said computing means for performing the color matching logic operation and determining the concentration of the said solution;
switches coupled to the said computing means, wherein the said switches are used for switching ON the instrument, resetting, commanding the instrument for operations in various modes;
a display means for displaying the test results.

20) A calorimeter operating on color matching logic as claimed in claim 19, wherein a closed loop control mechanism is used to keep the pre-test quality and intensity of the RGB and/or extra frequency/frequencies of the flame illumination at predetermined defined values, the said mechanism comprising:
the flame temperature is kept as constant as possible by using a specific defined type of the combustible gas;
a dark image and a source image is obtained by the sensor and inputted to the computing means;
the computing means determines the corrected source image;
the desired defined output for the said flame illumination is stored in the memory means;
combustible gas input to the said flame is regulated by the flame control block, wherein, the flame control block may control the flow using valves, where, the said control may be accomplished using servomechanism or fluid amplifier mechanism to regulate the flow of the combustible gas, and wherein, the flame control block is controlled by the control commands from the computing means;
the said computing means determines the required variation in the analog/digital input to the flame control block depending on the feedback signals obtained from the sensor means and the memory means;
the sensor inputs the said dark image and the said source image to the computing means;
the memory means inputs the stored RGB and/or extra frequency/frequencies values of the desired defined output to the computing means and the said computing means weighing them against the said corrected source image;
the computing means determines the mode of attunement by either increase or decrease in the said gas input and accordingly modifies the combustible gas input to the flame through the flame control block for attaining the pretest desired defined light output by the flame;
the cycle of the feedback input to the computing means and the computing means varying the combustible gas input to the flame appropriately is continued till the ultimate permissible/tolerable intensity and quality of RGB and/or extra frequency/frequencies composition of the said flame is achieved.
